(19) United States
(12) Patent Application Publication
(10) Pub. No.: US 2014/0002559 A1
(43) Pub. Date: Jan. 2, 2014

(54) INK JET PRINTING APPARATUS

(71) Applicant: CANON KABUSHIKI KAISHA, Tokyo (JP)

(72) Inventors: Akihiro Taya, Yokohama-shi (JP); Masanobu Ootsuka, Tokyo (JP)

(73) Assignee: CANON KABUSHIKI KAISHA, Tokyo (JP)

(21) Appl. No.: 13/896,632

(22) Filed: May 17, 2013

(30) Foreign Application Priority Data
Jun. 29, 2012 (JP) 2012-146778

(51) Int. Cl. B41J 11/00

(52) U.S. Cl. CPC B41J 11/002
USPC 347/102

(57) ABSTRACT

An ink jet printing apparatus has a conveying unit which conveys a sheet in a certain direction, a printing unit which performs printing with an ink on a conveyed sheet, and a blower unit which sends wind to an area in which printing is carried out by the printing head unit. The blower unit has a fan duct for sending the wind along the direction toward the area from diagonally above on an upstream side of the area.

### BACKGROUND OF THE INVENTION

1. Field of the Invention

The present invention relates to an ink jet printing apparatus having a means for drying ink discharged to form an image on a sheet.

2. Description of the Related Art

An ink jet printing apparatus which has a blower mechanism (cross-flow fan) to dry ink discharged from a printing head onto a sheet has been disclosed in Japanese Patent Application Laid-Open No. H06-126952. In the ink jet printing apparatus, the blower mechanism is provided farther on the downstream side than a printing area, in which the printing head performs printing, in the conveyance direction of a sheet. The wind generated by the blower mechanism passes above the sheet to dry the ink on the sheet and passes through an exhaust duct to be emitted out of the ink jet printing apparatus.

According to the invention disclosed in Japanese Patent Application Laid-Open No. H06-126952, the blower mechanism is provided farther on the downstream side than the printing area, thus making it possible to blow wind onto the sheet to dry ink immediately after the printing head discharges the ink onto the sheet. If, however, the sheet is a material that does not easily absorb water, then the ink on the sheet is not adequately dried in some cases even when air is sent as described above. The inadequately dried ink may lead to smudged ink or deteriorated granularity thereof, resulting in a failure to accomplish printing in accurate accordance with printing data.

### SUMMARY OF THE INVENTION

Accordingly, an object of the present invention is to provide an ink jet printing apparatus capable of solving the drawback described above and capable of efficiently drying ink discharged on a sheet.

To this end, an ink jet printing apparatus according to the present invention has a conveying mechanism which conveys a sheet; a printing head which discharges ink onto a sheet; a blower mechanism which generates wind; and a fan duct which is connected to the blower mechanism and which sends the wind generated by the blower mechanism to a printing area in which the printing head discharges ink onto the sheet, wherein the blower mechanism is disposed farther on an upstream side than the printing head in the conveyance direction of the sheet, and the blowing direction of the fan duct intersects with the conveyance direction of the sheet, as observed in a side view, while being parallel thereto, as observed in a plan view.

The blower mechanism, which blows wind to the printing area, is disposed on the upstream side beyond the printing head, so that the air with a lower humidity on the upstream side of the printing area can be supplied to the printing area rather than the air with a higher humidity in the printing area and on the downstream side thereof in the ink jet printing apparatus. This allows the ink on the sheet to be efficiently dried.

Further features of the present invention will become apparent from the following description of exemplary embodiments with reference to the attached drawings.

### BRIEF DESCRIPTION OF THE DRAWINGS

FIG. 1 is a sectional view of an ink jet printing apparatus having a blower mechanism in accordance with the present invention.

FIG. 2 is an enlarged detail view of the fan duct illustrated in FIG. 1.

FIG. 3 is a plan view illustrating a state in which the blower mechanism is blowing air to a printing area in FIG. 1.

FIG. 4 is a plan view illustrating a state in which the blower mechanism is blowing air to the printing area in the case where the ink jet printing apparatus illustrated in FIG. 1 is not provided with the fan duct.

FIG. 5 is an enlarged view illustrating a relationship between the fan duct illustrated in FIG. 1 and blockage.

FIG. 6 is a sectional view of a first comparison example of an ink jet printing apparatus having a blower mechanism disposed in a different position from that in the construction according to the present invention.

FIG. 7 is a sectional view of a second comparison example of an ink jet printing apparatus having a blower mechanism disposed in a different position from that in the construction according to the present invention.

FIG. 8 is a sectional view of a third comparison example of an ink jet printing apparatus having a blower mechanism disposed in a different position from that in the construction according to the present invention.

### DESCRIPTION OF THE EMBODIMENTS

Preferred embodiments of the present invention will now be described in detail in accordance with the accompanying drawings.

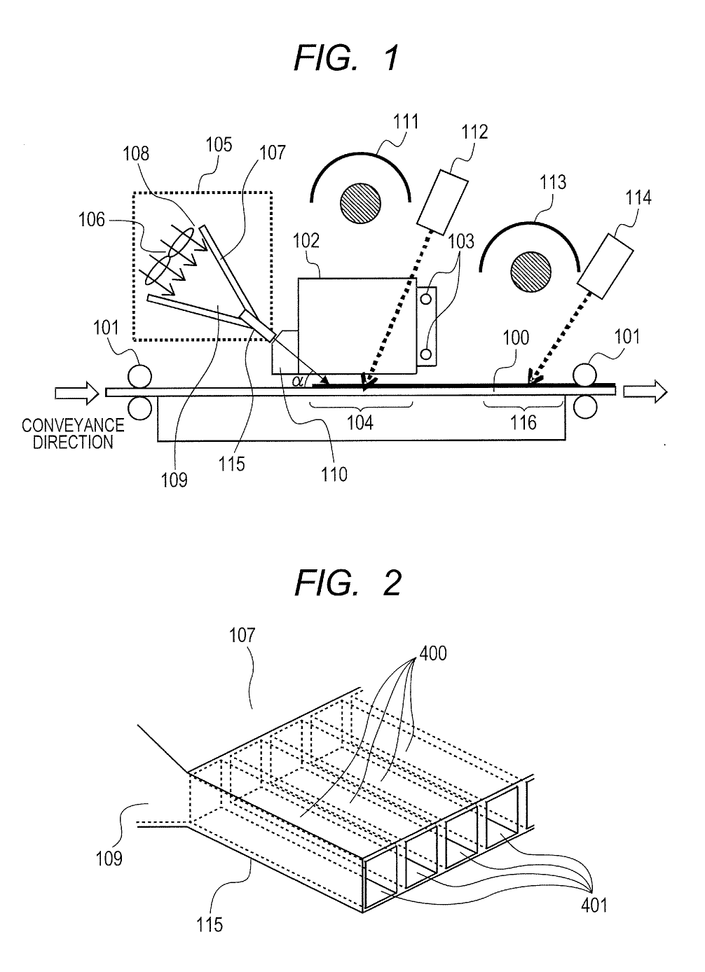

FIG. 1 is a sectional view illustrating an ink jet printing apparatus that has a blower mechanism used in an embodiment of the present invention.

The ink jet printing apparatus has a conveyance roller (conveyance mechanism) 101 for conveying a sheet 100, which is a printing medium on which an image is to be printed, from upstream to downstream in the horizontal direction, and a head unit 102 (printing unit) constituted of an ink jet head and a carriage, on which the ink jet head is mounted, for discharging ink onto the sheet 100. The head unit 102 reciprocates in a direction that intersects (orthogonally to) the direction in which the sheet 100 is conveyed by the carriage. An operation for discharging ink from the ink jet head during a travel thereof to print one band of image and an operation for step-feeding the sheet by one band at a time are repeated so as to form an image in a serial manner on the sheet.

The sheet that is used by the apparatus according to the present embodiment is a low-absorbability sheet that does not have a receptive layer of vinyl chloride or the like that repels water (hereinafter referred to as “the sheet with no receptive layer”). The ink to be used is a resin emulsion ink which is characteristic in that the water content in the ink evaporates when heat is applied to the ink on the sheet and then the ink softens and forms a film. Since the sheet is the low-absorbability sheet with no receptive layer, the ink applied will not permeate the sheet and remain on the surface thereof. Heating the ink causes the ink to form a film, leading to considerably improved weatherability, water resistance, and wear resistance of an image.

The carriage of the head unit 102 is attached to guide rails 103, which allow the carriage to be reciprocated by a driving force of a carriage motor. Provided adjacently to the head unit 102 is a blower mechanism 105 disposed on the upstream side with respect to the head unit 102 in the conveyance direction of the sheet 100. The blower mechanism 105 has a blower fan 106, a wind collecting hood 107, and a fan duct 115. The blower fan 106, which is a fan for generating wind, is in communication with external air so as to take in low-humidity air from the outside of the ink jet printing apparatus. The wind collecting hood 107, which is a hood for collecting the wind generated by the blower fan 106, has an intake port 108 provided in the vicinity of the blower fan 106 and an exhaust port 109 connected to the fan duct 115. The fan duct 115 is directed toward a printing area 104, in which the head unit 102 discharges the ink onto the sheet 100, and the blowing direction of the fan duct 115 intersects at an angle with the conveyance direction of the sheet 100, as observed sideways.

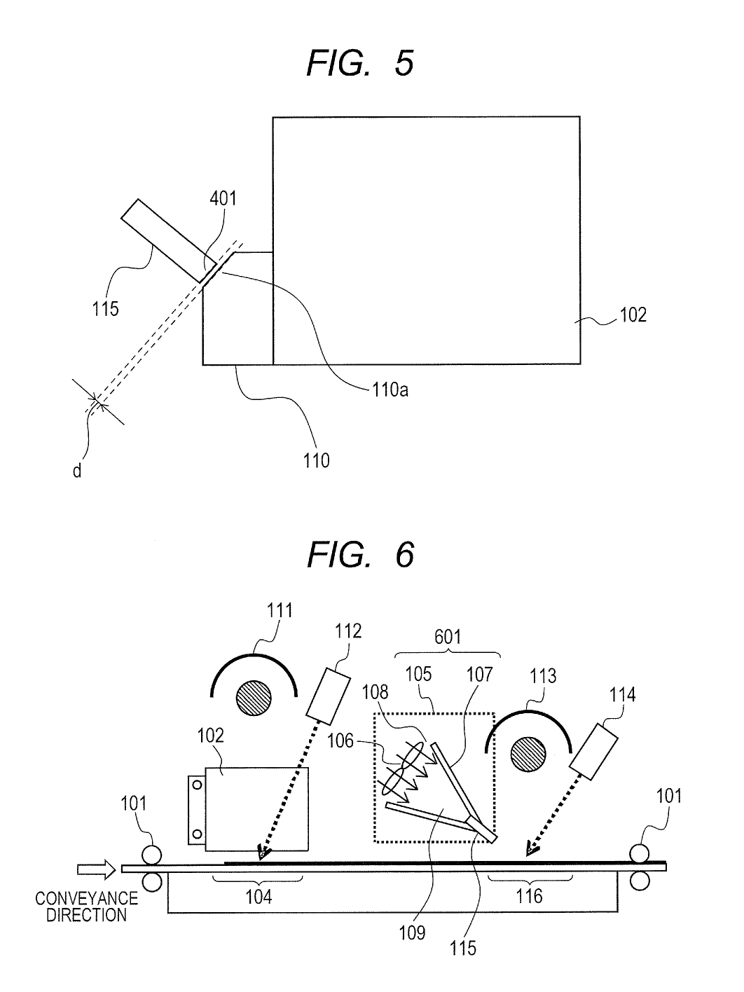

The fan duct 115 has a plurality of slits 400 for rectifying the wind sent from the blower fan 106 such that the wind linearly flows in the conveyance direction of the sheet 100 and outlets 401 through which the wind is blown out from the fan duct, as illustrated in FIG. 2. On the side portion of the head unit 102 on the upstream side, a blockage 110 is provided in the vicinity of the outlets 401 of the fan duct to block the flow of the wind supplied through the outlets 401. As illustrated in FIG. 5, the blockage 110 has a slant shielding surface 110a, which opposes the outlets 401 of the fan duct 115 in a noncontact manner with a small gap provided therebetween. The effect for blocking the wind increases as a gap “d” decreases. The gap “d” is preferably set to, for example, 1 mm or less.

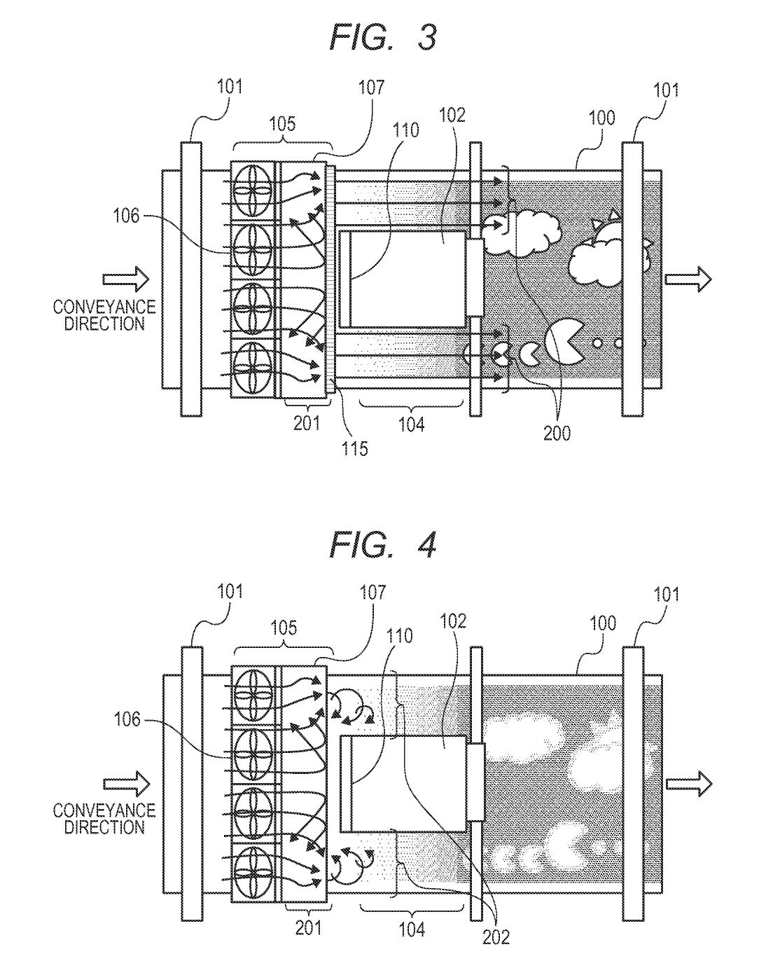

As illustrated in FIG. 3, the fan duct 115 has a width that is larger than the width of the sheet 100 in order to supply wind in a direction substantially parallel to the conveyance direction, as observed from above, over the whole area of the sheet 100. A part of the wind evenly blown out of the wide outlets 401 of the fan duct 115 is blocked by the shielding surface 110a of the blockage 110 of the head unit 102. As the position of the head unit 102 changes, the position at which the blockage 110 blocks the outlets 401 changes accordingly.

A heater 111, which is a first heating unit, is disposed above the printing area 104 to expedite the drying of the ink in the printing area 104. Further, a noncontact thermometer 112 is provided to detect the temperature of the printing area 104. The noncontact thermometer 112 detects the temperature of the printing area 104 and transmits a signal to the heater 111 according to the temperature so as to control the energy output by the heater 111, thereby adjusting the heat energy supplied to the printing area 104. Thus, the printing area 104 is a first drying area 104 for drying the ink. Further, a second drying area 116 for enhancing the robustness of the ink by drying and removing the water content in the ink is provided on the downstream side of the printing area 104. A heater 113, which is a second heating unit, and a noncontact thermometer 114 are provided in the second drying area 116. The second drying area 116 is set to apply more heat energy to the sheet than the heat energy in the first drying area 104.

A description will now be given of the background of the invention of the ink jet printing apparatus having the aforesaid configuration. As mentioned above, there are cases where adequate drying is not accomplished even when the wind is applied to the sheet by the blower mechanism in Japanese Patent Application Laid-Open No. H06-126952. This, the inventors assumed, is because the wind directed to the sheet contains moisture. More specifically, it is considered that, in some cases, a part of the ink discharged toward the sheet in the printing area is scattered and the water content in the ink is captured into the air around the printing area, so that even when the air, the humidity of which has been increased thereby, is applied to the sheet, the ink on the sheet cannot be adequately dried. It has also been considered to combine a heater for heating and a blower mechanism for blowing air in order dry the ink more efficiently. In the case disclosed in Japanese Patent Application Laid-Open No. H06-126952, a platen in the printing area is provided with a heater, and the heater transmits the heat to the sheet thereby to accelerate the evaporation of the water content in the ink. When the water content in the ink, which has been heated by the heater, evaporates into the air, the humidity in the air increases. Applying the air with the increased humidity to the sheet does not contribute much to improved drying efficiency despite the addition of the heater. More heaters could be used to improve the drying efficiency. In this case, however, an additional heater would be disposed on the downstream side of the printing area so as to heat a printed sheet. With this arrangement, a space on the downstream side of the printing area of the ink jet printing apparatus would be filled with higher-humidity air containing the moisture that has been heated by the two heaters and evaporated. Then, the blower mechanism positioned on the downstream side of the printing area would blow the higher-humidity air to the sheet. According to this method, however, the air with even higher humidity would be applied to the sheet, so that not much effect for improving the drying efficiency can be expected despite of the increased number of the heaters.

As a result of the studies described above, the inventors have reached a conclusion that the ink on the sheet can be efficiently dried with air with a lower humidity by supplying, to the sheet, the air on the upstream side of the printing area, which is considered to contain less moisture captured therein from the ink. Hence, according to the present invention, the blower mechanism is provided on the upstream side of the printing area, as described above, to blow air toward the sheet. With this arrangement, even when a heater exists in the printing area and on the downstream side thereof, the air containing the moisture evaporated from the heating by the heater will not be led to the printing area. In fact, the air containing the moisture is pushed toward the downstream side away from the printing area and exhausted to the outside. According to the constitution, therefore, the high-humidity air will not be blown onto the sheet, and instead, the low-humidity air on the upstream side of the printing area is blown onto the sheet, thus leading to higher drying efficiency. In this configuration, providing heaters in the printing area and on the downstream side thereof will not interfere with the operation for evaporating the water content in the ink.

The method for drying the ink on the sheet by the ink jet printing apparatus described above will be explained in further detail.

Upon receipt of printing data, the ink jet printing apparatus feeds the sheet 100 to the conveyance roller 101 from a paper feed tray (not shown) in which the sheet 100 is set. The method for feeding the sheet 100 to the conveyance roller 101 uses an automatic feeder (not shown) using a motor as a drive source thereof. The sheet 100 supplied to the conveyance roller 101 is conveyed from upstream to downstream by a conveying force of the conveyance roller 101. When the sheet 100 reaches the printing area 104, the head unit 102, the blower mechanism 105 and the heater 111 are actuated.

The head unit 102 discharges the ink onto the sheet 100 while reciprocating over the sheet 100 along the guide rails 103 to form an image on the sheet 100 according to the received image data. The discharged ink linearly flies to the sheet 100 and lands on the surface of the sheet 100 in the printing area 104.

In the blower mechanism 105, the blower fan 106 runs to take into the blower mechanism 105 the external air or low-humidity wind from the upstream side of the printing area 104, while the wind collecting hood 107 collects the wind to the exhaust port 109 from the intake port 108. The wind collected into the exhaust port 109 enters the fan duct 115 and then the wind is rectified by the slits 400 of the fan duct so as to be substantially parallel to the conveyance direction of the sheet 100, as observed from above, before being sent to the printing area 104. As illustrated in FIG. 3, if the head unit 102 in the reciprocating motion is not positioned to oppose the fan duct 115, then the outlets 401 of the fan duct will not be blocked by the blockage 110, so that the wind will be linearly sent to the printing area 104. If, however, the head unit 102 is positioned to oppose the fan duct 115, then the blockage 110 blocks the outlets 401 of the fan duct, so that the wind will not be sent from the outlets 401 of the fan duct. The wind that has been blocked by the blockage 110 and has not been sent to the printing area 104 returns to the wind collecting hood 107, disturbing the wind flow in the wind collecting hood 107. However, the slits 400 of the fan duct linearly correct the flow of the wind toward the outlets 401 of the fan duct. Hence, the wind that has been disturbed in the wind collecting hood 107 is linearly sent toward the printing area 104 through the outlets 401 of the fan duct that are not blocked by the blockage 110.

If the blockage 110 were not present, then the gap between the fan duct 115 and the head unit 102 would increase and the air sent through the outlets 401 of the fan duct bounces off the wall surface of the opposing head unit 102, causing a turbulence to occur in the gap. The turbulence disturbs the flow of the wind linearly flown by the outlets 401 of the fan duct before the wind reaches the printing area 104. Hence, the wind will not be supplied to the whole area of the printing area 104, resulting in deteriorated ink drying efficiency. Further, in the case where the ink jet printing apparatus does not have the fan duct 115 as illustrated in FIG. 4, if the wind is blocked by the blockage 110 and returns to the wind collecting hood 107, disturbing the wind flow, then the wind remaining in the disturbed state will be inconveniently sent. This prevents the wind from being sent to the whole area of the printing area 104, deteriorating the ink drying efficiency. Further, a failure of ink discharge may result due to the disturbed wind turning onto the ink discharge surface of the head unit 102, causing the ink discharge surface to dry up.

Meanwhile, if the direction of the wind sent from the fan duct 115 of the blower mechanism 105 and the wall surface of the blockage 110 opposing the fan duct 115 intersect with each other at an acute angle as observed in a side view, then the wind will inconveniently flow from the outlets 401 of the fan duct along the wall surface of the blockage 110. This causes the wind to be directed to the ink discharge surface of the head unit 102. The wind from the blower mechanism 105 turning onto the ink discharge surface of the head unit 102 will dry the ink discharge surface, possibly leading to an ink discharge failure. To prevent the problem, the wind generated by the blower mechanism 105 is sent such that an acute angle is formed between the wind and the conveyance direction of the sheet 100, as observed in the side view. The conveyance direction of the sheet 100 and the wall surface of the blockage 110 are orthogonal to each other. Therefore, if the direction of the wind being sent and the conveyance direction of the sheet 100 form an acute angle as observed in the side view, then the direction of the wind and the wall surface of the blockage 110 intersect with each other at an obtuse angle as observed in the side view. This means that the wind flowing from the outlets 401 of the fan duct will not move along the wall surface of the blockage 110, thus eliminating the possibility of the wind turning onto the ink discharge surface of the head unit 102. An angle α at which the direction of the wind sent and the conveyance direction of the sheet 100 intersect with each other is preferably 20 degrees or less.

The heater 111 receives electric energy from a power source (not shown) to generate heat energy. The heat energy generated by the heater 111 is transmitted to the first drying area 104 and imparted to the ink on the sheet 100. Applying excessive heat to the first drying area 104 will burn the sheet 100; therefore, the noncontact thermometer 112, which is provided in the vicinity of the heater 111, detects the temperature at the first drying area 104. Whether the heat energy transmitted to the first drying area 104 is excessive or deficient is determined by monitoring the temperature on the noncontact thermometer 112, and the amount of the heat energy to be generated by the heater 111 is controlled to maintain the temperature at the first drying area 104 at a constant level. The temperature at the first drying area 104 is set at an optimum temperature for each type of ink, because different types of ink contain different amounts of water content.

The ink discharged from the head unit 102 onto the sheet 100 in the first drying area 104 as described above is subjected to the wind sent from the blower mechanism 105 and the heat generated by the heater 111, thereby evaporating the water content in the ink. However, the first drying area 104 alone cannot adequately evaporate the water content in the ink. Therefore, another heater 113 is provided at a downstream deep portion, which is an area on the downstream side of the printing area 104, so as to form a second drying area 116.

As the sheet 100 is conveyed further to the downstream after passing the first drying area 104, the sheet reaches the second drying area 116. The moment the sheet 100 reaches the second drying area 116, the heat energy that is higher than the heat energy generated by the heater 111 is applied to the sheet 100 from the heater 113. The heater 113 receives electric energy from a power source (not shown) to generate the heat energy. The heat energy generated by the heater 113 is transmitted to the second drying area 116 and imparted to the ink on the sheet 100. The temperature of the second drying area 116 is detected by a noncontact thermometer 114 provided in the vicinity of the heater 113. Whether the heat energy transmitted to the second drying area 116 is excessive or deficient is determined by monitoring the temperature on the noncontact thermometer 114, and the amount of the heat energy to be generated by the heater 113 is controlled to maintain the temperature at the second drying area 116 at a constant level. The temperature at the second drying area 116 is set at an optimum temperature for each type of ink, because different types of ink contain different amounts of water content.

The water content in the ink evaporated by the heater 113 in the second drying area 116 is likely to fill the space on the downstream side of the printing area 104. According to the present embodiment, however, the blower mechanism 105 is positioned on the upstream side of the head unit 102, so that the high-humidity air will not be sent to the printing area 104, and instead, the external air or the low-humidity air on the upstream side of the printing area 104 will be sent to the printing area 104.

Further, the drying in the second drying area 116 is also expedited by sending the wind thereto from the blower mechanism 105 on the upstream side of the printing area 104 while heating the ink by the heater 113. Thus, according to the present embodiment, the wind can be sent to the two drying areas 104 and 116, each of which has a heater, by a single blower mechanism 105 positioned on the upstream side of the printing area 104. This makes it possible to prevent the configuration from becoming complicated and to control an increase of the size of the entire ink jet printing apparatus and an increase of the manufacturing cost.

In other words, according to the present embodiment, since the blower mechanism 105 is disposed on the upstream side of the head unit 102, the wind sent out from the blower mechanism 105 flows from the upstream to the downstream. In addition, as previously described, the direction of the wind set from the blower mechanism 105 intersects with the conveyance direction of the sheet 100 at an acute angle as observed in the side view, so that the direction of the sent wind is nearly horizontal. Hence, the wind is blown onto the sheet 100 in the first drying area 104 and then the wind flows toward the second drying area 116 along the direction in which the sheet 100 advances. The wind sent to the first drying area 104 takes the water content from the ink in the first drying area 104, so that the humidity of the wind becomes higher than that immediately after the wind is sent out from the blower mechanism 105; however, the wind is still capable of sufficiently contributing to expediting the drying of the ink by the heater 113 in the second drying area 116.

Thus, in the second drying area 116, the ink on the sheet 100 is subjected to the wind sent from the blower mechanism 105 and the heat generated by the heater 113 so as to remove the water content from the ink, allowing highly robust printing on the sheet 100 to be achieved.

After passing through the second drying area 116, the sheet 100 which has a printed object drawn with the dried ink on the front surface thereof is ejected into a catch tray (not shown) by the conveyance roller 101.

(Comparative Experiments on the Configuration According to the Present Invention and Other Configurations)

The ink jet printing apparatus according to an embodiment of the present invention and ink jet printing apparatuses having different configurations have been used to carry out experiments to assess three aspects, namely, the deterioration in the image of a printed object on the sheet 100, the discharge failure of a nozzle, and the robustness of the ink of the printed object. The experiment results will be described below.

(Ink Used)

The ink used for the printing contains much resin emulsion. To be more specific, after blending the ingredients shown below, the mixture was adjusted to have pH=9 in a potassium hydroxide solution.

| | |
|---|---|
| pigment | 20 parts |
| 2-pyrrolidone | 15 parts |
| 2-methyl-1,3-propanediol | 5 parts |
| MEGAFAC (registered trademark) F444 (made by DIC) | 1.0 parts |
| Joncryl (registered trademark) 537J | 10.0 parts |
| ion-exchanged water | remainder |

The following four types of pigments were used to prepare inks of four colors.

Cabot Corporation CAB-O-JET (registered trademark) 200

Cabot Corporation CAB-O-JET (registered trademark) 250C

Cabot Corporation CAB-O-JET (registered trademark) 260M

Cabot Corporation CAB-O-JET (registered trademark) 270Y

(Printing Apparatus Used)

The printing apparatus used is Canon ink jet printer iPF-5100. The resolution for printing is set to 1200 dpi (dots per inch) in the vertical scanning direction and 2400 dpi in the horizontal scanning direction.

(Heater Used)

The heaters 111 and 113 used are SAKAGUCHI 640W sheathed heaters.

(Thermometers Used)

The noncontact thermometers 112 and 114 used are KEYENCE digital radiation temperature sensors FT-H20.

(Blower Mechanism Used)

The blower fan 106 used is AINEX CFZ-120R. The wind collecting hood 107 is formed of a 1 mm-thick aluminum plate, and the fan duct 115 used is formed of an aluminum member having holes spaced at 5-mm intervals, each hole having a diameter of 4 mm and a length of 5 cm.

(Sheet Used)

The sheet 100 used is a sheet with no receptive layer, and specifically, KIMOTO white glossy PVC film KSM-SE.

### Comparative Example 1

As illustrated in FIG. 6, comparative example 1 is configured such that a blower mechanism 105 is disposed at a position 601 on the downstream rather than the upstream of a head unit 102, and the wind is sent only to a second drying area 116.

### Comparative Example 2

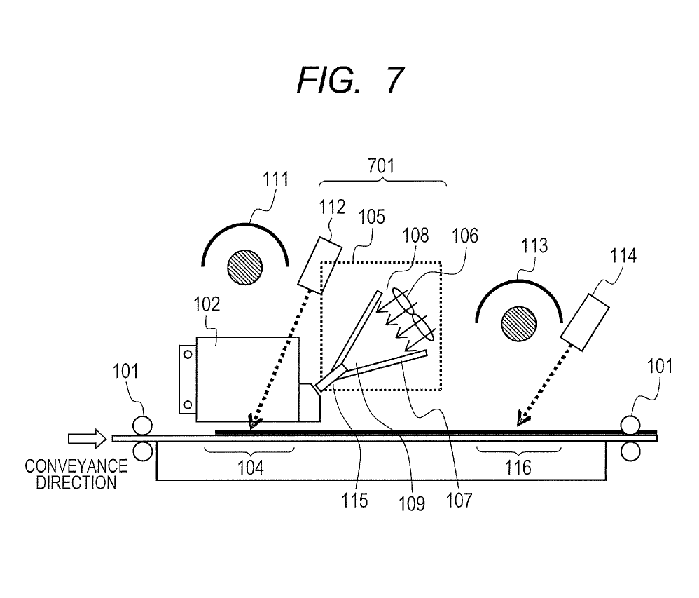

As illustrated in FIG. 7, comparative example 2 is configured such that a blower mechanism 105 is disposed at a position 701 on the downstream rather than the upstream of a head unit 102, and the wind is sent only to a first drying area 104.

### Comparative Example 3

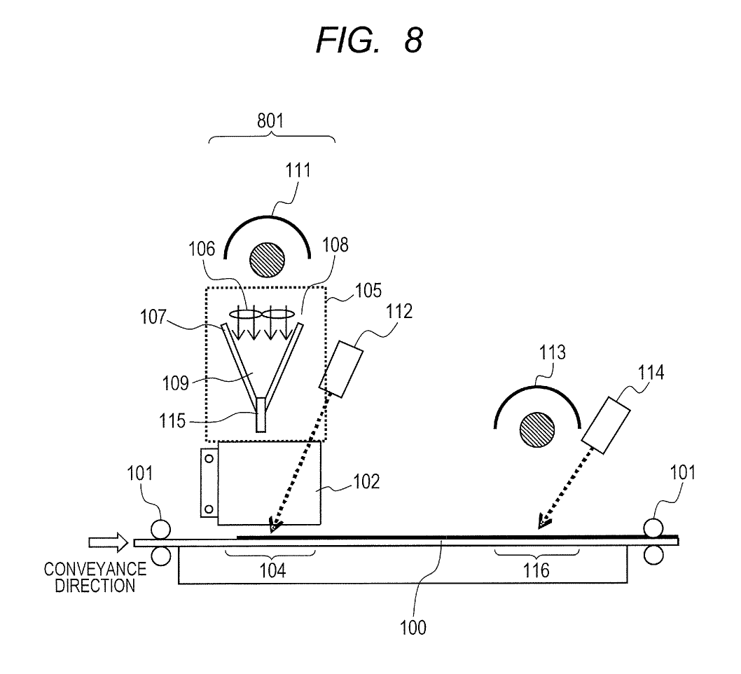

As illustrated in FIG. 8, comparative example 3 is configured such that a blower mechanism 105 is disposed at a position 801 between a head unit 102 and a heater 111, and the wind is sent only to a first drying area 104.

(Experiment Method)

The volume per ink drop is set to 4.8 picoliter, the distance between the sheet 100 and the ink discharge surface of the head unit 102 is set to 2.5 mm, the wind speed of the blower fan 106 is set to 3 m/s, the temperature of the heater 111 is set to 60° C., and the temperature of the heater 113 is set to 85° C.

The sheet 100 is set on a paper feed tray (not shown), and the sheet 100 is fed to a printing area 104 by a conveyance roller 101. In the printing area 104, an image is printed on the sheet 100. The size of the image to be printed is A4. After the inks are discharged onto the surface of the sheet 100, the sheet 100 passes the second drying area 116 and is ejected into a catch tray (not shown).

The deterioration of printed images was visually and subjectively assessed. If a printed image approximately coincided with original photograph data, then the assessment result was indicated by “A”. If a printed image exhibited an image defect, such as suspended ink mist or the misdirection of an ink landing position, then the assessment result was indicated by “B”. If a printed image exhibited an image defect, such as a deteriorated granularity or a smudged color, then the assessment result was indicated by “C”.

Regarding the assessment of a nozzle discharge, if no ink discharge failure happened while printing one A4-size sheet, then the assessment result was indicated by “A”, or if a discharge failure happened with a resultant streak in an image, then the assessment result was indicated by “C”.

The robustness of the inks on the printed objects was assessed by scraping the printed objects with a nail. If no peeling of the ink was observed, then the assessment result was indicated by “A”, or if the ink peeled off, exposing the sheet 100, then the assessment result was indicated by “C”.

(Experiment Results)

Table 1 shows the results of the experiments.

TABLE 1

| | | Comparative | Comparative | Comparative |
|---|---|---|---|---|
| | Embodiment | Example 1 | Example 2 | Example 3 |
| Image | A | C | C | B |
| quality | | | | |
| Nozzle | A | A | A | C |
| discharge | | | | |
| Image | A | A | C | C |
| robustness | | | | |

The assessment results of the embodiment of the present invention indicate that all the image quality, the nozzle discharge, and the ink robustness of the printed object were “A”. This proves that sending the wind to the first drying area 104 and the second drying area 116 by the blower mechanism 105 from the upstream of the head unit 102 leads to the improved drying efficiency due to the heat of the heaters 111 and 113, no image deterioration and high ink robustness of a printed object. Further, the blower mechanism 105 sends the wind at an acute angle in the conveyance direction of the sheet 100, as observed in a side view, so that the wind is not directed toward the ink discharge surface of the head unit 102. Thus, no ink discharge failures took place.

The assessment results of comparative example 1 indicated that the nozzle discharge and the ink robustness of the printed object were “A”, whereas the image quality was “C”. This is because the blower mechanism 105 sends the wind toward the second drying area 116, so that the ink is not dried in the first drying area 104, although the turning of the wind toward the ink discharge surface of the head unit 102 is prevented and the drying of the ink in the second drying area 116 is expedited. It is seen, therefore, sending the wind to the first drying area 104 prevents image deterioration.

The assessment results of comparative example 2 indicated that the nozzle discharge was “A”, whereas the image quality and the ink robustness of the printed object were “C”. The blower mechanism 105 sends the wind at an acute angle to the sheet 100, as observed in a side view, so that the wind did not turn toward the ink discharge surface of the head unit 102 and no ink discharge failure occurred. No wind was sent to the second drying area 116, resulting in poor ink robustness due to incomplete removal of the water content in the ink on the sheet 100. Meanwhile, the image quality deteriorated despite the wind sent toward the first drying area 104. This is because the wind sent by the blower mechanism 105 contained humidity, thus causing the ink to be incompletely dried in the first drying area 104.

The assessment results of comparative example 3 indicate that the image quality was “B”, the nozzle discharge and the ink robustness of the printed object were “C”. This is because the blower mechanism 105 vertically sent the wind to the sheet 100, so that the wind sent onto the sheet 100 and bounced wind caused a turbulent flow, which deteriorated the image. Further, a turbulent flow was generated in the printing area 104, causing the wind to turn onto the ink discharge surface of the head unit 102. This led to an ink discharge failure. In addition, since no wind was sent to the second drying area 116, the water content in the ink on the sheet 100 was not completely removed, leading to the poor ink robustness.

The results described above indicate that the embodiment of the present invention expedites the drying of ink by sending low-humidity wind to the first drying area 104 and the second drying area 116, thus accomplishing a highly robust printed object free of deterioration on the sheet 100. Moreover, the wind can be sent to the first drying area 104 and the second drying area 116 by the single blower mechanism 105, obviating a complicated configuration and permitting reduced manufacturing cost. In addition, the wind does not turn toward the ink discharge surface of the head unit 102, thus preventing the occurrence of an ink discharge failure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-146778, filed on Jun. 29, 2012, which is hereby incorporated by reference herein in its entirety.

What is claimed is:

1. An ink jet printing apparatus comprising:
a conveying unit which conveys a sheet in a direction;
a printing unit which carries out printing on a conveyed sheet with an ink; and
a blower unit which sends wind to an area in which printing is carried out by the printing unit;
wherein the blower unit sends wind along the direction toward the area from diagonally above on an upstream side of the area.

2. The ink jet printing apparatus according to claim 1,
wherein the printing unit has a carriage on which an ink jet head is mounted and reciprocates above the area in a direction that is orthogonal to the direction.

3. The ink jet printing apparatus according to claim 2,
wherein the blower unit has an outlet through which the wind is blown out in a range that covers the area in a direction in which the carriage moves, and a part of the wind blown out of the outlet is blocked by the printing unit.

4. The ink jet printing apparatus according to claim 3,
wherein the printing unit is provided with a blockage which opposes the outlet in a noncontact manner with a gap therebetween to block the wind.

5. The ink jet printing apparatus according to claim 3,
wherein the blower unit has a fan and a duct with the outlet which sends the wind generated by the fan toward the area, and a plurality of slits for directing the wind blown out of the duct in the direction is provided in the vicinity of the outlet.

6. The ink jet printing apparatus according to claim 5,
wherein the blower unit has a hood for supplying the wind generated by the fan to the duct.

7. The ink jet printing apparatus according to claim 1, further comprising:
a first heater for heating the sheet in the area; and
a second heater for heating the sheet on a downstream side of the area in the direction.

8. The ink jet printing apparatus according to claim 7,
wherein the sheet is a sheet that does not have a receptive layer, and the ink is a resin emulsion ink.
